(19) United States
(12) Patent Application Publication
(10) Pub. No.: US 2006/0133660 A1
(43) Pub. Date: Jun. 22, 2006

(54) Apparatus and method for detecting defect existing in pattern on object

(75) Inventors: Hiroshi Ogi, Kyoto (JP); Hiroyuki Onishi, Kyoto (JP); Yasushi Sasa, Kyoto (JP); Yuichiro Hikida, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/289,708

(22) Filed: Nov. 30, 2005

(30) Foreign Application Priority Data
Dec. 16, 2004 (JP) P2004-363900

(51) Int. Cl. G06K 9/00

(52) U.S. Cl. 382/149; 382/144

(57) ABSTRACT

In a defect detection apparatus 1, in a reference image inspection circuit 42 compared are a reference image representing a pattern in a die which is determined as a reference on a substrate 9 and a plurality of supervisory images which represent patterns in selected block areas, respectively, to detect defects included in the reference image. Subsequently, in the target image inspection circuit 44, a target image representing a pattern in another die and the reference image are compared to detect a plurality of defect candidates included in the target image. Then, a defect detector 45 excludes defect candidates overlapping with the defects included in the reference image from the plurality of defect candidates on the basis of at least positional information of the defects included in the reference image. This makes it possible to detect defects existing in the pattern in another die accurately while eliminating effects of the defects existing in the pattern in the die which is determined as the reference.

### BACKGROUND OF THE INVENTION

1. Field of the Invention

The present invention relates to a technique for detecting a defect existing in a pattern on an object.

2. Description of the Background Art Various inspection methods have been conventionally used in a field of inspecting an appearance of a semiconductor substrate, a printed circuit board, a photomask, a lead frame and the like. Japanese Patent Application Laid Open Gazette No. 8-189898 (Document 1), for example, discloses a technique for detecting defects of a pattern on a printed circuit board on which the same pattern blocks are arrayed, where one or more pattern blocks are read out and stored as a reference pattern and an inspection pattern other than the reference pattern is compared with the reference pattern to detect defects.

Japanese Patent Application Laid Open Gazette No. 5-264464 (Document 2) suggests a defect detection apparatus for detecting defects in pattern inspection of a semiconductor memory or the like on which a fine pattern is formed, where data of images of a plurality of pattern blocks are sequentially acquired as multivalued digital signals and the data of images are sequentially compared with corresponding data of images of adjacent pattern blocks which are prepared by delay of the signal, to detect defects. Japanese Patent Application Laid Open Gazette No. 11-40638 (Document 3) suggests a defect detection apparatus for detecting defects of patterns on a plurality of dies (pellets) each of which is to become a chip in a semiconductor substrate, where an image of one whole die serving as a reference is picked up and stored as a reference pattern and the reference pattern is compared with a picked-up image of a pattern formed on the other die at every position on the semiconductor substrate, to detect defects.

In the defect detection apparatus shown in Document 2, however, if there is a continuous slight change in shape for arrayed patterns, the difference in comparison between adjacent pattern blocks is very small and this disadvantageously makes it impossible to detect any defect. The defect detection apparatus shown in Document 3 solves this problem, but if defects exist in a pattern formed on the die serving as the reference, the same positions as these defects are detected as defects also in the other dies to be inspected.

### SUMMARY OF THE INVENTION

The present invention is intended for an apparatus for detecting a defect existing in a pattern on an object. It is an object of the present invention to detect a defect existing in a pattern in a block area accurately in consideration of defect existing in a pattern in another block area which is determined as a reference.

According to the present invention, the apparatus comprises an image pickup part for picking up an image of an object on which a predetermined pattern is formed in each of a plurality of block areas, a reference image inspection part for detecting a defect included in a reference image representing a pattern in a block area which is determined as a reference on an object by comparing the reference image with a plurality of supervisory images each of which represent a pattern in selected block area, a target image inspection part for detecting at least one defect candidate included in a target image representing a pattern in another block area by comparing the target image with the reference image, and a defect detector for excluding a defect candidate overlapping with the defect included in the reference image from at least one defect candidate on the basis of at least positional information of the defect included in the reference image.

According to the present invention, it is possible to detect a defect existing in the pattern in another block area accurately by detecting a defect existing in the pattern in the block area which is determined as the reference.

According to one preferred embodiment of the present invention, since the defect detector excludes a defect candidate overlapping with the defect included in the reference image from at least one defect candidate also on the basis of feature value of the defect included in the reference image and feature value of at least one defect candidate, it is possible to detect a defect existing in another block area more accurately.

According to another preferred embodiment of the present invention, the apparatus further comprises a display for displaying a defect candidate excluded by the defect detector distinguishably from the other defect candidate, and by checking out the defect candidate displayed in the display, it is possible to reconfirm a excluded defect candidate, even if the excluded defect candidate is a defect.

According to an aspect of the present invention, since one inspection part functions as the reference image inspection part and the target image inspection part, it is possible to reduce hardware resources in the apparatus. According to another aspect of the present invention, since a plurality of target images are acquired by the image pickup part, and at lease one of the plurality of supervisory images is included in the plurality of target images, it is possible to reduce time required for a defect detection of the pattern on the object.

Also, in a case where a pattern in each of the plurality of block areas on an object is formed with changing process parameters gradually in accordance with two-dimensional positions of the plurality of block areas, since the block area which is determined as the reference and at least one block area corresponding to at least one of the plurality of supervisory images are adjacent to each other, it is possible to detect a defect existing in the pattern in the block area which is determined as the reference accurately and detect a defect existing in the pattern in another block area more accurately.

The present invention is also intended for a method of detecting a defect existing in a pattern on an object.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a constitution of a defect detection apparatus in accordance with a first preferred embodiment;

FIG. 2 is a plan view showing a substrate;

FIG. 3 is a flowchart showing an operation flow for detecting defects existing in a pattern on the substrate;

FIG. 4 is a flowchart showing an operation flow for inspecting a reference image;

FIG. 5 is a view showing an image displayed in a display;

FIG. 6 is a view explaining a measurement result of a process margin;

FIG. 7 is a view showing other example of a processor of the defect detection apparatus;

FIG. 8 is a view showing a constitution of a processor of a defect detection apparatus in accordance with a second preferred embodiment; and

FIG. 9 is a view showing a constitution of a processor of a defect detection apparatus in accordance with a third preferred embodiment.

### DESCRIPTION OF THE PREFERRED EMBODIMENTS

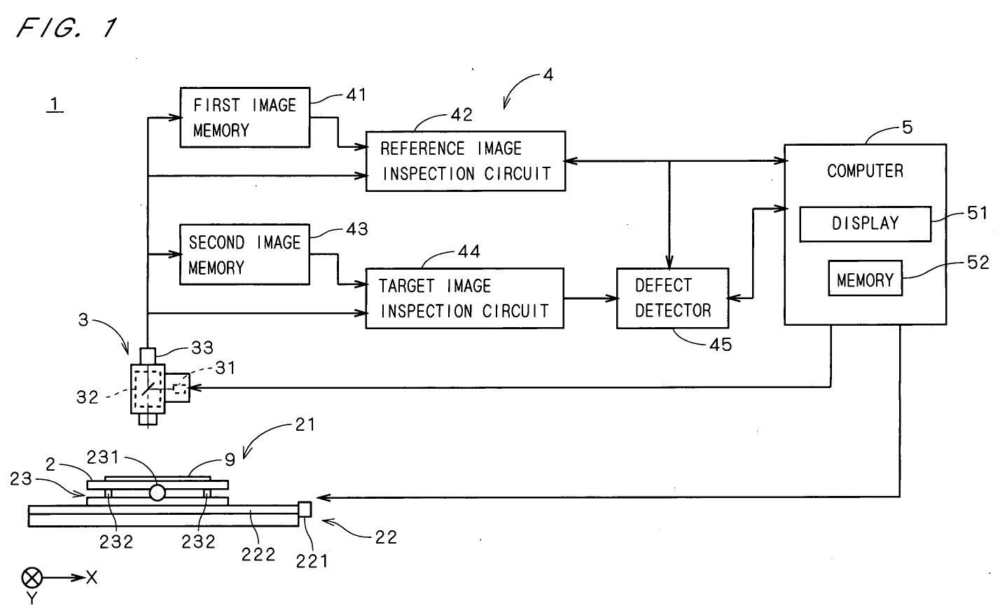

FIG. 1 is a view showing a constitution of a defect detection apparatus 1 in accordance with the first preferred embodiment of the present invention. The defect detection apparatus 1 is an apparatus for detecting defects existing in a pattern on a semiconductor substrate (hereinafter, referred to as “substrate”) 9 on which fine patterns are formed. There may be a case where the number of “defects” is zero or one.

The defect detection apparatus 1 comprises a stage 2 for holding the substrate 9, an image pickup part 3 for picking up an image of the substrate 9 to acquire grayscale image data of the substrate 9, a stage driving part 21 for moving the image pickup part 3 relatively to the substrate 9 on the stage 2, a processor 4 constituted of various electric circuits, and a computer 5 constituted of a CPU for performing various computations, a memory for storing various pieces of information and the like. The computer 5 controls these constituent elements of the defect detection apparatus 1.

The stage driving part 21 has an X-direction moving mechanism 22 for moving the stage 2 in the X direction of FIG. 1 and a Y-direction moving mechanism 23 for moving the stage 2 in the Y direction. The X-direction moving mechanism 22 has a motor 221 to which a ball screw (not shown) is connected and with rotation of the motor 221, the Y-direction moving mechanism 23 moves along guide rails 222 in the X direction of FIG. 1. The Y-direction moving mechanism 23 has the same structure as the X-direction moving mechanism 22 has, and with rotation of a motor 231, the stage 2 is moved along guide rails 232 in the Y direction of FIG. 1 by a ball screw (not shown).

The image pickup part 3 has a lighting part 31 for emitting an illumination light, an optical system 32 which guides the illumination light to the substrate 9 and receives a light from the substrate 9, an image pickup device 33 for converting an image of the substrate 9 which is formed by the optical system 32 into an electrical signal, and the image data of the substrate 9 is outputted from the image pickup device 33. Though the image is acquired by the image pickup part 3 with an illumination light which is a visible light in the present preferred embodiment, for example, an electron beam, an ultraviolet ray, an X-ray or the like may be used to acquire images.

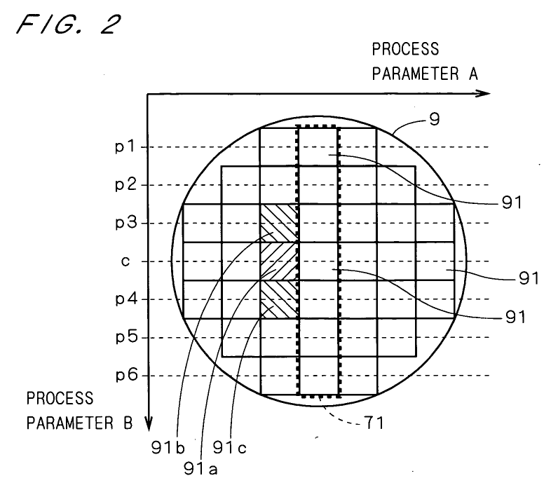

FIG. 2 is a plan view showing the substrate 9. The substrate 9 comprises a plurality of block areas (hereinafter, referred to as “dies”) 91 each of which is to be subjected to dicing in the later step to obtain a semiconductor chip, and predetermined wiring patterns are formed in a plurality of dies 91, respectively. Respective dies 91 are repeated both in the horizontal and vertical directions to be arranged. In the present preferred embodiment, image data is acquired with respect to each die 91 by the image pickup part 3, and the acquired data is outputted to the processor 4 of FIG. 1.

The processor 4 has a first image memory 41 for a reference image inspection for storing an inputted image of a predetermined die 91, an reference image inspection circuit 42 for performing an inspection of the later-discussed reference image, a second image memory 43 for a target image inspection for storing the reference image used in inspecting a target image, a target image inspection circuit 44 for comparing the target image to be inspected with the reference image, and a defect detector 45 which is connected to the reference image inspection circuit 42 and the target image inspection circuit 44. The computer 5 has a display 51 for displaying various information such as images and the like, a memory 52 for storing various pieces of information, and an operation part.

Further discussion will be made on the substrate 9 of FIG. 2 to be inspected in the present preferred embodiment. The patterns in the plurality of dies 91 on the substrate 9 of FIG. 2 are formed with changing predetermined process parameters A and B (for example, a focus position and exposure time) gradually in accordance with two-dimensional positions of the plurality of dies 91 in an exposure step in forming the patterns, the patterns are used to acquire so-called process margins which are allowable ranges of parameters in the exposure step. The patterns in the plurality of dies 91 on the substrate 9 may be formed with changing process parameters used in another step in forming the patterns.

In such a substrate 9, generally, the process parameters of a die 91 located in the center of the substrate 9 are the optimal values (or values which are thought to be the optimal values), process parameters of the other dies 91 are increased or decreased from the optimal values of the central die 91 of FIG. 2 in accordance with the horizontal and vertical positions, and the substrate 9 for confirmation of process margins is prepared. In a plurality of dies 91 surrounded by a dashed rectangle 71 of FIG. 2, for example, the process parameter A is kept constant, the process parameter B is changed to p1, p2, p3, c, p4, p5, and p6 from the upper die 91, and each die 91 is formed. With respect to the process parameter B, a value c for the central die 91 is the optimal value. Hereinafter, mere “substrate 9” means the substrate 9 for confirmation of the process margins.

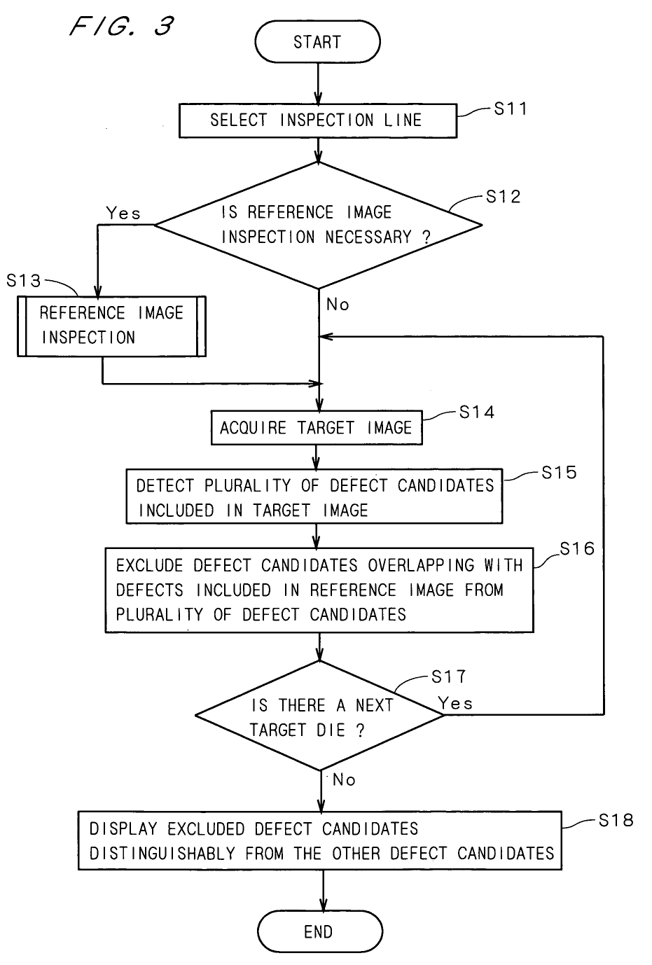

FIG. 3 is a flowchart showing an operation flow of the defect detection apparatus 1 for detecting defects existing in a pattern on the substrate 9. In the defect detection apparatus 1, first, a line of the plurality of dies 91 surrounded by the rectangle 71 in the substrate 9 of FIG. 2 is selected as an inspection line to be inspected (Step. S11). In the following description, each die 91 included in the inspection line is called a target die 91 to be distinguished from the other dies.

In the defect detection apparatus 1, one die in the vicinity of the central part of the substrate 9 (i.e., a die which is formed at process parameters which are close to the optimal values, respectively, and to which a reference sign 91a is assigned in FIG. 2) is related to the inspection line in advance as a die which is determined as a reference in inspecting (hereinafter, the die is referred to as “reference die”). When the inspection line is selected, an inspection of an image representing a pattern in the reference die 91a (hereinafter, the image is referred to as “reference image”) is performed (Steps S12, S13). One die included in the inspection line is determined as the reference die and may be used to be distinguished from the other target dies 91.

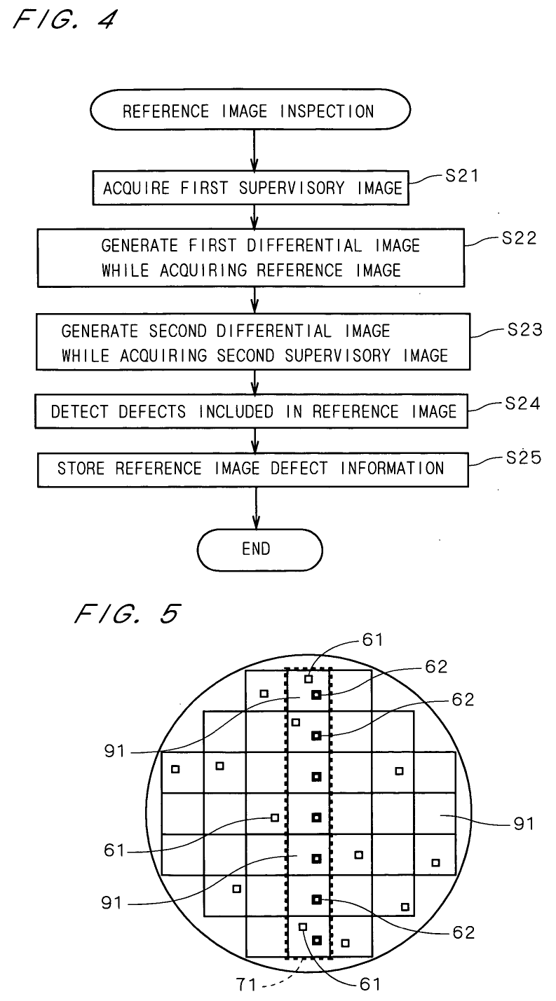

FIG. 4 is a flowchart showing an operation flow for inspecting the reference image, and it shows the operation performed in Step 13 of FIG. 3. In a reference image inspection, a die 91b adjacent to the reference die 91a is selected (or it has selected in advance relative to the reference die 91a) by a user (hereinafter, the selected die is referred to as “supervisory die”), an image representing a pattern in the supervisory die 91b (hereinafter, the image is referred to as “first supervisory image”) is acquired by the image pickup part 3 to be stored in the first image memory 41 of the processor 4 for the reference image inspection (Step S21).

Next, the reference image is acquired by the image pickup part 3, each pixel value of the reference image is sequentially outputted to both the reference image inspection circuit 42 and the first image memory 41 and a corresponding pixel value of the first supervisory image is outputted from the first image memory 41 to the reference image inspection circuit 42. In the reference image inspection circuit 42, an absolute value of the difference between each pixel value of the reference image and the corresponding pixel value of the first supervisory image is calculated, in a case where the value is equal to or greater than a predetermined threshold value, a pixel value indicating a defect is generated, and in a case where the value is smaller than the threshold value, a pixel value indicating a non-defect (normal) is generated. With this operation, a binary differential image (hereinafter, referred to as “first differential image”) is acquired while acquiring the reference image, and the acquired differential image is stored in a memory of the reference image inspection circuit 42 temporarily (Step S22). At this time, each pixel value of the reference image is also inputted to the second image memory 43 for the target image inspection.

After the first differential image is generated, another supervisory die 91c adjacent to the reference die 91a is selected, and each pixel value of a supervisory image representing a pattern in the supervisory die 91c (hereinafter, the image is referred to as “second supervisory image”) is sequentially inputted to both the reference image inspection circuit 42 and the first image memory 41. Then, an absolute difference value between each pixel value of the second supervisory image and a corresponding pixel value of the reference image outputted from the first image memory 41 is calculated and compared with the predetermined threshold value, to generate a pixel value indicating a defect or a pixel value indicating a non-defect (Step S23). Step S23 substantially corresponds to a step for generating another differential image (hereinafter, referred to as “second differential image”) while acquiring the second supervisory image.

In the reference image inspection circuit 42, further, a generated pixel value and a corresponding pixel value of the first differential image stored in the memory of the reference image inspection circuit 42 are compared, in a case where both pixel values are a value indicating a defect, a corresponding pixel of the reference image is determined as a defective pixel, and in the other cases (i.e., in a case where at least one pixel value is a value indicating a non-defect), the corresponding pixel of the reference image is determined as a non-defective pixel. Then, a group of defective pixels connecting one another is regarded as one defect through the labeling process, and defects included in the reference image are detected in the reference image inspection circuit 42 (Step S24). The defects included in the reference image may be acquired by comparing the reference image with three or more supervisory images and obtaining logical products of three or more differential images. In other words, a plurality of supervisory images are acquired in detecting the defects included in the reference image.

Information representing positions of the defects included in the reference image (hereinafter, referred to as “reference image defect information”) is outputted to the defect detector 45 to be stored in a memory of the defect detector 45 (Step S25). The reference image defect information, together with images representing the defects included in the reference image (i.e., images of local areas including the defects), is also outputted to the computer 5 to be stored in the memory 52. The images representing the defects included in the reference image, as necessary, are displayed in the display 51 of the computer 5, and defects existing in the reference die 91a are confirmed by the user. At this time, when the user determines a defect as a false defect (pseudo defect) from an image representing the defect existing in the reference die 91a displayed in the display 51, the user inputs information through an input part (not shown) of the computer 5, and then the reference image defect information stored in the defect detector 45 may be modified. In a case where an inspection of the pattern in the reference die 91a related to the inspection line has already performed in inspecting another inspection line to which the same die 91a is related as the reference and this inspection result can be utilized in present inspection, the above-described reference image inspection is not performed, and an inspection of an target image is performed directly as discussed below (FIG. 3: Step S12).

After the inspection of the reference image is completed (or the user judges the inspection of the reference image unnecessary), a target image representing a pattern in one target die 91 of a plurality of target dies 91 is acquired, each pixel value of the target image is sequentially outputted to the target image inspection circuit 44 and a corresponding pixel value of the reference image is outputted from the second image memory 43 for the target image inspection to the target image inspection circuit 44 (Step S14). At this time, since the reference image is stored in the second image memory 43 in advance concurrently with Step S22 of FIG. 4, the reference image does not need to be acquired again in the inspection of the target image, and time required for a defect inspection is reduced.

In the target image inspection circuit 44, an absolute difference value between each pixel value of the target image and the corresponding pixel value of the reference image is calculated, in a case where the value is equal to or greater than a predetermined threshold value, the pixel of the target image is determined as a defect candidate pixel, and in a case where the value is smaller than the threshold value, the pixel of the target image is determined as a non-defective pixel. A group of defect candidate pixels connecting one another is regarded as one defect candidate through the labeling process, and a plurality of defect candidates included in the target image are detected in the target image inspection circuit 44 (Step S15). Information representing positions of the plurality of defect candidates included in the target image (hereinafter, referred to as “defect candidate information”) and images representing the plurality of defect candidates included in the target image are outputted to the defect detector 45.

The defect detector 45 compares the position of each defect candidate in the target image represented by the defect candidate information with positions of the defects in the reference image represented by the reference image defect information, in a case where a position of a defect candidate in the target image and a position of any one of defects in the reference image are the same (or the distance between both positions is within a predetermined range (same as the following)), the defect candidate is thought to be caused by the defect in the reference image to be excluded from the defect candidate information. An image representing an excluded defect candidate (i.e., an image of a local area including the excluded defect candidate (false defect)) and information representing a position of the excluded defect candidate are outputted to the computer 5 to be stored in the memory 52. In other words, the defect detector 45 excludes defect candidates overlapping with the defects included in the reference image from the plurality of defect candidates on the basis of positional information of the defects included in the reference image (Step S16). As for defect candidates of which positions represented by the defect candidate information are not the same as positions of any defects, information of the defect candidates is left in the defect candidate information, and the defect candidate information and images representing the defect candidates (images of local areas including the defect candidates which are not excluded) are outputted to the computer 5 to be stored in the memory 52.

In the defect detection apparatus 1, the above Steps S14 to S16 are repeated to each of the remaining target dies 91 (Step S17), a plurality of defect candidates included in each target image are acquired and defect candidates overlapping with the defects included in the reference image are excluded from the plurality of defect candidates. With this operation, true defects (in this inspection) are detected in each of the plurality of target dies 91.

After inspection of all the target dies 91 is completed (Step S17), as necessary, another inspection line is selected, and a reference image inspection of another reference die (which may be the same reference die 91a) and an inspection of target images are performed (step relative to another inspection line is omitted in FIG. 3). Then, as shown in FIG. 5, the display 51 of the computer 5 displays defect candidates 62 (false defects) excluded by the defect detector 45 distinguishably from the other defect candidates 61 (i.e., which are true defects in this inspection, and hereinafter, also referred to simply as “defect candidates”) (Step S18). Not all defect candidates and all defects are shown in FIG. 5. In FIG. 5, though excluded defect candidates 62 are shown distinguishably from the other defect candidates 61 by drawing with thick lines, actually, the excluded defect candidates 62 are displayed distinguishably from the other defect candidates 61 by differing a color of rectangles showing respective areas of the excluded defect candidates 62 from the defect candidates 61, or displaying the defect candidates 61 and the excluded defect candidates 62 in separate windows, respectively.

In the computer 5, when the user selects any of the defect candidates 61 or any of the excluded defect candidates 62 through the input part (not shown), an enlarged image of a selected defect candidate is displayed in the display 51. The user checks out the defect candidate(s) 61 displayed in the display 51 and for example, it is possible to classify a class of the defect candidate 61. The user checks out the excluded defect candidate(s) 62 displayed in the display 51, and it is possible to reconfirm the excluded defect candidate 62, even if the excluded defect candidate 62 is a defect.

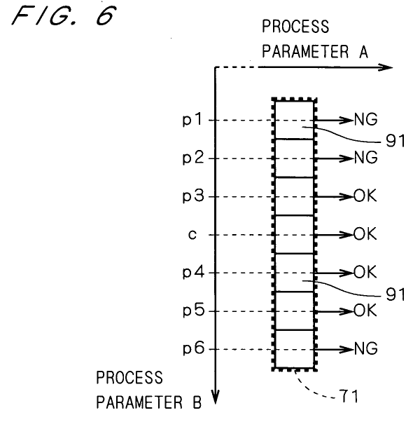

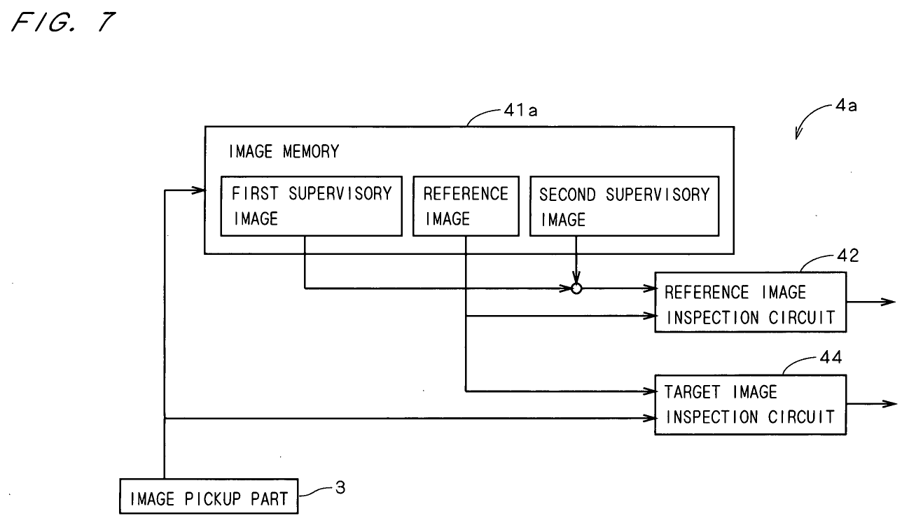

With respect to the substrate 9, by determining whether a shape or characteristics of the wiring pattern of each die 91 is in an allowable range on the basis of the inspection result in the defect detection apparatus 1 or an inspection result such as electrical characteristics of a wiring pattern in another apparatus, it becomes possible to measure the process margin more accurately. In FIG. 6, “OK” or “NG” is assigned to each die 91 included in the inspection line, and this shows a check result whether the characteristics of the wiring pattern of each die 91 is in the allowable range.

As discussed above, in the defect detection apparatus 1 of FIG. 1, the defects included in the reference image are detected by comparing the reference image with the plurality of supervisory images and the plurality of defect candidates included in the target image are detected by comparing the target image with the reference image, to exclude the defect candidates overlapping with the defects included in the reference image from the plurality of defect candidates. This makes it possible to detect the defects existing in the pattern in the target die(s) accurately while eliminating effects of the defects existing in the pattern in the reference die.

In the defect detection apparatus 1, since the dies adjacent to the reference die 91a are selected as the supervisory dies 91b, 91c, the process parameters in forming the supervisory dies 91b, 91c are close to the optimal values. Thus a possibility that defects caused by changing process parameters from the optimal values exist in the supervisory dies 91b, 91c is low. Conversely, in a case where a plurality of dies formed in positions apart from the reference die 91a are selected as the supervisory dies and these supervisory dies are adjacent to each other, there is a possibility that the same defects (or a defect) caused by changing process parameters from the optimal value exist in both supervisory dies. In this case, detective pixels are detected in the same positions of a plurality of differential images between a plurality of supervisory images and the reference image so that false defects are detected in the reference image, and many false defects are detected in an inspection of a target image(s) using the reference image. From this viewpoint, to detect the defects existing in the pattern in the reference die 91a accurately, it is preferable that at least one die corresponding to at least one of the plurality of supervisory images is adjacent to the reference die 91a and thereby, defects existing in a pattern in a target die are detected more accurately.

Even if in the case where the plurality of dies formed in the positions away from the reference die 91a are selected as the supervisory dies, when these supervisory dies are away from each other, characteristics of defects caused by the process parameters are respectively different, and it is possible to detect the defects existing in the pattern in the reference die 91a accurately. From this viewpoint, in the case where the plurality of dies formed in the positions away from the reference die 91a are selected as the supervisory dies, it is preferable that the center of the reference die 91a and the centers of at least two supervisory dies are a distance corresponding to two dies (i.e., two block areas) or more away from one another.

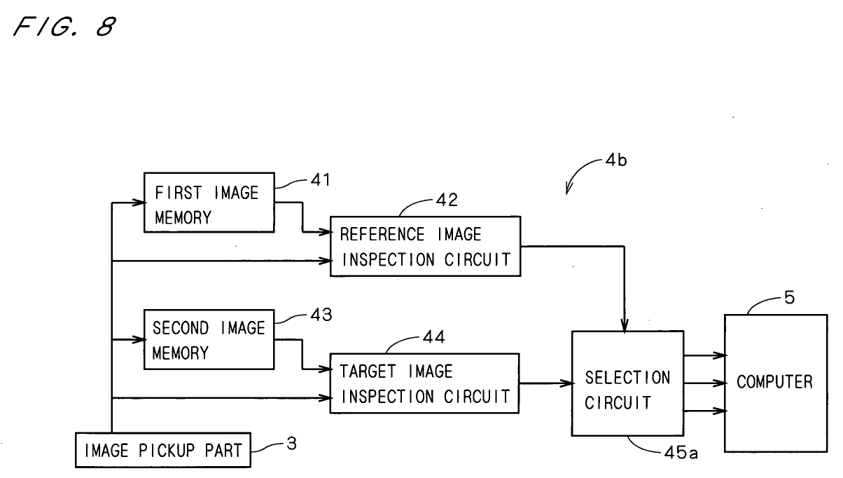

In the defect detector 45 of the processor 4 of FIG. 1, in determining the defect candidates in the target image overlapping with the defects in the reference image, feature values of the defects may be utilized further (the same applies to processors 4a to 4c of FIG. 7 to FIG. 9 discussed later).

Specifically, the feature values of the defects (for example, geometric features such as areas (i.e., the number of pixels) of the defects or circumscribed rectangles of the defects, luminance of the defects, or the like) in the reference image are further obtained in addition to the reference image defect information in the reference image inspection circuit 42 to be stored in the memory of the defect detector 45 together with the reference image defect information. In inspecting the target image, the same feature values of the plurality of defect candidates in the target image are obtained together with the defect candidate information by the target image inspection circuit 44. In the defect detector 45, in a case where a position of a defect candidate in the target image is the same as a position of any one of defects in the reference image and a feature value(s) of the defect candidate also approximates a feature value(s) of the defect of the same position in the reference image (the difference between both feature values is in a predetermined range, for example), the defect candidate is excluded from the defect candidate information, and in a case where both the feature values do not approximate each other, the defect candidate is not excluded. In other words, in addition to the reference image defect information the defect detector 45 excludes defect candidates overlapping with the defects included in the reference image from the plurality of defect candidates in the target image also on the basis of the feature values of the defects included in the reference image and the feature values of the plurality of defect candidates in the target image corresponding to the positions of the defects of the reference image. This makes it possible to detect the defects existing in the pattern in the target die 91 more accurately. The defect detector 45 determines defect candidates in the target image overlapping with the defects in the reference image on the basis of at least the reference image defect information, and thereby it is possible to detect the defects existing in the pattern in the target die 91 at a constant accuracy.

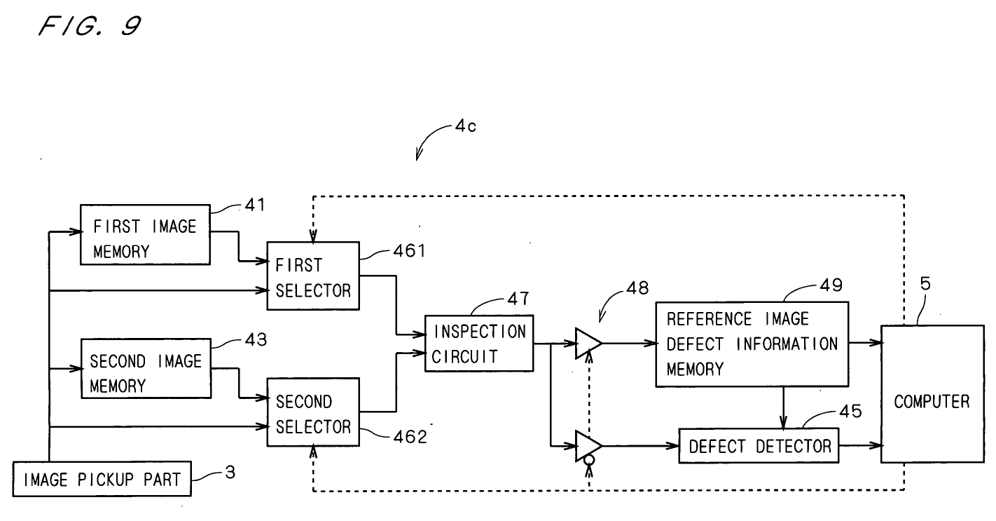

FIG. 7 is a view showing other example of a processor of the defect detection apparatus 1. In a processor 4a in accordance with the other example, the second image memory 43 used in the target image inspection in the processor 4 of FIG. 1 is omitted, and the first image memory 41 used in the reference image inspection is replaced with one image memory 41a having a storage area which is possible to store images of three dies 91. In the defect detection apparatus 1 having the processor 4a of FIG. 7, the first supervisory image, the reference image, and the second supervisory image acquired in the reference image inspection step of Step S13 of FIG. 3 are stored in the image memory 41a. After the inspection of the reference image is performed in the same way as in the above description, each pixel value of the reference image is read out from the image memory 41a in the inspection of target image, and inputted to the target image inspection circuit 44 to be compared with a corresponding pixel value of the target image. By this, in the processor 4a of FIG. 7 one memory is used in both the reference image inspection and the target image inspection. Also in processors 4b, 4c of FIG. 8 and FIG. 9 discussed later, the second image memory 43 is omitted, and one image memory 41a having a large capacity may be prepared in the same way as the processor 4a.

FIG. 8 is a view showing a constitution of a processor 4b of a defect detection apparatus in accordance with the second preferred embodiment of the present invention. In comparison with the processor 4 of FIG. 1, the processor 4b of FIG. 8 substitutes a selection circuit 45a outputting three kinds of signals to the computer 5 for the defect detector 45 and operations in each of the reference image inspection circuit 42 and the target image inspection circuit 44 are different. Other constituent elements are the same as those of FIG. 1 and the same reference signs are used in the following discussion. Discussion will be made on an operation flow of the defect detection apparatus having the processor 4b of FIG. 8 for detecting defects existing in a pattern on a substrate 9 according to FIG. 3 and FIG. 4.

In the same way as the first preferred embodiment, in the defect detection apparatus, after an inspection line is selected (Step S11), the image pickup part 3 picks up an image of a supervisory die adjacent to a reference die 91a to acquire a first supervisory image, to be stored in the first image memory 41 for the reference image inspection (Steps S12, S13, S21). Subsequently, while acquiring a reference image, an absolute difference value between corresponding pixel values of the reference image and the first supervisory image is obtained in the reference image inspection circuit 42, in a case where the value is equal to or greater than a predetermined threshold value, a value “1” indicating a defect is generated, and in a case where the value is smaller than the threshold value, a value “0” indicating a non-defect is generated, to generate a first differential image (Step S22). The first differential image is stored in the memory of the reference image inspection circuit 42. Each pixel value of the reference image is also outputted to the second image memory 43 for the target image inspection to be stored.

Subsequently, a target image of one target die 91 is acquired (Step S14), an absolute difference value between corresponding pixel values of the target image and the reference image is obtained in the target image inspection circuit 44. In a case where the value is equal to or greater than a predetermined threshold value, a value “1” indicating a defect candidate is generated, and in a case where the value is smaller than the threshold value, a value “0” indicating a non-defect is generated, to be outputted to the selection circuit 45a (Step S15). At this time, a corresponding pixel value of the first differential image is inputted simultaneously to the selection circuit 45a from the reference image inspection circuit 42. As discussed later, since a differential image between the target image and the reference image is used in an inspection of the reference image, an operation for detecting defect candidates in this embodiment is also corresponding to an operation for generating a second differential image (Step S23).

In the selection circuit 45a, in a case where a value (pixel value) outputted from the reference image inspection circuit 42 is 1 and a value (pixel value) outputted from the target image inspection circuit 44 is also 1, a value which indicates the corresponding pixel of the reference image is a defective pixel is outputted to the computer 5, and in a case where a value outputted from the reference image inspection circuit 42 is 0 and a value outputted from the target image inspection circuit 44 is 1, a value which indicates the corresponding pixel of the target image is a defect candidate pixel is outputted to the computer 5. With this operation, in the selection circuit 45a, defect candidates overlapping with defects included in the reference image are excluded substantially from a plurality of defect candidates while detecting the defects included in the reference image (Steps S16, S24). When the value outputted from the target image inspection circuit 44 is 0, a value which indicates the corresponding pixel of the target image is a non-defective pixel is outputted in spite of the value outputted from the reference image inspection circuit 42.

In the defect detection apparatus, the above steps (Steps S14 to S16, S23, S24) are repeated to each of the remaining target dies 91 (Step S17). Defect candidates (i.e., the same positions in the target die 91 as defects existing in the reference die 91a) excluded in each of a plurality of target dies 91 are displayed in the display 51 (see FIG. 1) distinguishably from the other defect candidates (Step S18). If a defect candidate which is not excluded exists in the same positions in one target die 91 as an excluded defect candidate exists in another target die 91, by determining priorities to the plurality of target dies 91 in advance, inspection results in both the target dies 91 are made to become the same.

As discussed above, in the defect detection apparatus having the processor 4b of FIG. 8, a plurality of target images are acquired by the image pickup part 3, and each target image is also used as one of supervisory images. This achieves a high accurate defect detection in consideration of the defects existing in the pattern in the reference die 91a while reducing time required for a defect detection of the pattern on the substrate 9 by saving time for acquiring one supervisory image.

In the processor 4b, by making the selection circuit 45a store positional information (reference image defect information) of the defects in the reference image obtained in inspecting the initial target image, in inspecting the remaining target images, defect candidates overlapping with the defects included in the reference image may be excluded from the plurality of defect candidates on the basis of the existing reference image defect information, as in the first preferred embodiment. In this case, one of two supervisory images is included in the plurality of target images. In inspecting the reference image, in a case where, for example, three supervisory images are acquired, two supervisory images are included in the plurality of target images and the defects of the reference image may be detected. As stated above, since at least one of a plurality of supervisory images is included in the plurality of target images acquired by the image pickup part 3, it is possible to reduce time required for a defect detection.

FIG. 9 is a view showing a constitution of a processor 4c of a defect detection apparatus in accordance with the third preferred embodiment of the present invention. The processor 4c of FIG. 9 has a first selector 461 connected to the image pickup part 3 and the first image memory 41 for the reference image inspection, and a second selector 462 connected to the image pickup part 3 and the second image memory 43 for the target image inspection. The first and second selectors 461, 462 are connected to one inspection circuit 47. The inspection circuit 47 is connected to a switching circuit 48 in a downstream side, and an output from the inspection circuit 47 is switched to a reference image defect information memory 49 or the defect detector 45. The memory of the defect detector 45 is independently provided as the reference image defect information memory 49 in the processor 4c.

When the defect detection apparatus having the processor 4c of FIG. 9 detects defects existing in a pattern, first, an inspection line is selected (FIG. 3: Step S11), an image of a supervisory die adjacent to a reference die 91a is picked up, and a first supervisory image is stored in the first image memory 41 (Steps S12, S13, FIG. 4: Step S21). Subsequently, a reference image is acquired, each pixel value of the reference image is sequentially inputted to the first image memory 41, the first selector 461, the second image memory 43, and the second selector 462 and a corresponding pixel value of the first supervisory image is inputted from the first image memory 41 to the first selector 461. At this time, the first selector 461 selects an output from the first image memory 41 on the basis of a signal from the computer 5 to input the first supervisory image to the inspection circuit 47, and in the second selector 462, the reference image acquired by the image pickup part 3 is selected to be inputted to the inspection circuit 47. Then, in the inspection circuit 47, each pixel value of the first supervisory image and a corresponding pixel value of the reference image are compared to generate a first differential image (Step S22). The first differential image is stored in a memory of the inspection circuit 47.

After the first differential image is generated, a second supervisory image is acquired, each pixel value of the second supervisory image is sequentially inputted to the first image memory 41, the first selector 461, and the second selector 462 (at this time, writing to the second image memory 43 is not performed) and a corresponding pixel value of the reference image is inputted from the first image memory 41 to the first selector 461. The first selector 461 selects an output from the first image memory 41, the second selector 462 selects the second supervisory image acquired by the image pickup part 3, so that a second differential image is generated in the inspection circuit 47 (Step S23).

The inspection circuit 47 compares corresponding pixel values of the first differential image and the second differential image to detect defects included in the reference image (Step S24), the inspection circuit 47 is connected to the reference image defect information memory 49 by the switching circuit 48 on the basis of a signal from the computer 5, and reference image defect information and images representing the defects included in the reference image are stored (Step S25).

After the reference image defect information is stored, a target image of one target die 91 is acquired (FIG. 3: Step S14), and each pixel value of the target image is sequentially inputted to the first selector 461 and the second selector 462 (at this time, writings to the second image memory 43 and the first image memory 41 are not performed). The first selector 461 selects an output from the image pickup part 3 to output each pixel value of the target image to the inspection circuit 47, and the second selector 462 selects an output from the second image memory 43 to output a corresponding pixel value of the reference image to the inspection circuit 47. The inspection circuit 47 compares corresponding pixel values of the target image and the reference image to detect a plurality of defect candidates in the target image, and defect candidate information and images representing the plurality of defect candidates included in the target image are outputted to the defect detector 45 through the switching circuit 48 (Step S15).

The defect detector 45 excludes defect candidates overlapping with the defects included in the reference image from the plurality of defect candidates on the basis of the reference image defect information outputted from the reference image defect information memory 49 (Step S16). Defect candidates existing in all the target dies 91 included in the selected inspection line are detected, defect candidates overlapping with the defects included in the reference image are excluded (Step S17), and then excluded defect candidates are displayed in the display 51 (see FIG. 1) distinguishably from the other defect candidates (Step S18).

As discussed above, in the defect detection apparatus having the processor 4c of FIG. 9, one inspection circuit 47 functions as the reference image inspection circuit 42 and the target image inspection circuit 44 of the processor 4 of FIG. 1, by sequentially inputting the reference image and a plurality of supervisory images, and the target image and the reference image to the inspection circuit 47, the defects included in the reference image and the plurality of defect candidates included in the target image are detected. As a result, in the defect detection apparatus having the processor 4c, it is possible to detect defects existing in the pattern in the target die 91 accurately by detecting defects existing in the pattern in the reference die 91a while reducing hardware resources in comparison with the defect detection apparatus 1 of FIG. 1.

In the processor 4c of FIG. 9, at lease one of the plurality of supervisory images may be included in a plurality of target images acquired by the image pickup part 3. In inspecting the reference image, for example, only the first supervisory image and the reference image are acquired to generate the first differential image. In inspecting the target image, a differential image between the target image and reference image is obtained, and the plurality of defect candidates in the target image are detected. And this differential image and the first differential image are compared so that, while detecting the defects in the reference image, defect candidates overlapping with the defects of reference image are excluded from the plurality of defect candidates. Consequently, it is possible to reduce time required for a defect detection also in the processor 4c.

Though the preferred embodiments of the present invention has been discussed above, the present invention is not limited to the above-discussed preferred embodiments, but allows various variations.

Only one defect may exist in a reference image, though a plurality of defects are detected in the reference image in the above-discussed preferred embodiments. In this case, at least one defect candidate which includes a defect candidate derived from the defect of the reference image is detected from a target image, and one defect candidate overlapping with the defect of the reference image is excluded from at least one defect candidate on the basis of positional infomation of the defect of the reference image (and also, a feature value(s) of the defect in the reference image and a feature value(s) of at least one defect candidate).

Though in the above-discussed preferred embodiments the image data is acquired with respect to each die 91 by the image pickup part 3, for example, in a case where the image pickup device 33 of the image pickup part 3 is a line sensor, the substrate 9 is moved in a direction orthogonal to an arrangement direction of sensing (or photodetecting) elements in the line sensor while the line sensor is activated, and then image data of a strip-like area (so-called swath) which corresponds to one of a plurality of partial patterns (hereinafter, referred to as “divided patterns”) which are obtained by dividing one die 91 may be acquired. In this case, the inspection of the reference image and the inspection of the target image are performed while acquiring an image with respect to each swath and this achieves a high accurate defect detection of the pattern on the substrate 9 while reducing a memory capacity used by the processor.

By performing the inspection of the target image after the inspection of the reference image, the defect detection of the pattern is performed easily and efficiently in the above-discussed preferred embodiments, but the detection of the defects in the reference image is performed after the detection of the plurality of defect candidates in the target image, and then defect candidates overlapping with the defects included in the reference image may be excluded from the plurality of defect candidates.

Although in the above-discussed preferred embodiments the reference image inspection circuit 42 and the inspection circuit 47 in inspecting the reference image obtain the absolute difference value between the corresponding pixel values of the reference image and the plurality of supervisory images to detect the defects included in the reference image, the defects included in the reference image may be detected by using other techniques, for example, the absolute difference value between the pixel values are compared with a predetermined threshold value after normalization. In other words, if the reference image inspection circuit 42 and the inspection circuit 47 in inspecting the reference image detect the defects included in the reference image by comparing the reference image with the plurality of supervisory images, any techniques may be used. Also in the target image inspection circuit 44 and the inspection circuit 47 in inspecting the target image, if the plurality of defect candidates included in the target image are detected by comparing the target image with the reference image, other techniques may be used.

In a case where a detection of defects does not need to be performed at high speed in the defect detection apparatus, the same functions as all or a part of the processors 4 and 4a to 4c shown in FIG. 1 and FIG. 7 to FIG. 9 may be implemented by the computer 5 as software.

The substrate 9 is not limited to a substrate for confirmation of the process margin, and the substrate 9 may be a semiconductor substrate produced by applying a constant process parameter. Generally, in a semiconductor substrate, by positional dependence in various processes, a shape or the like of a pattern is changed depending on a position as the above-described substrate for confirmation of the process margin. The defect detection apparatus can detect defects existing in a pattern in a block area also on such a substrate accurately in consideration of defects existing in a pattern in another block area which is determined as a reference by performing an inspection of a reference image.

The substrate 9 is not limited to a semiconductor substrate but may be a printed circuit board having repeat patterns, a glass substrate or the like. An object whose defect is detected by the defect detection apparatus may be something other than the substrate.

While the invention has been shown and described in detail, the foregoing description is in all aspects illustrative and not restrictive. It is therefore understood that numerous modifications and variations can be devised without departing from the scope of the invention.

This application claims priority benefit under 35 U.S.C. Section 119 of Japanese Patent Application No. 2004-363900 filed in the Japan Patent Office on Dec. 16, 2004, the entire disclosure of which is incorporated herein by reference.

What is claimed is:

1. An apparatus for detecting a defect existing in a pattern on an object, comprising:
an image pickup part for picking up an image of an object on which a predetermined pattern is formed in each of a plurality of block areas;
a reference image inspection part for detecting a defect included in a reference image representing a pattern in a block area which is determined as a reference on an object by comparing said reference image with a plurality of supervisory images each of which represent a pattern in selected block area;
a target image inspection part for detecting at least one defect candidate included in a target image representing a pattern in another block area by comparing said target image with said reference image; and
a defect detector for excluding a defect candidate overlapping with said defect included in said reference image from said at least one defect candidate on the basis of at least positional information of said defect included in said reference image.

2. The apparatus according to claim 1, wherein
said defect detector excludes a defect candidate overlapping with said defect included in said reference image from said at least one defect candidate also on the basis of feature value of said defect included in said reference image and feature value of said at least one defect candidate.

3. The apparatus according to claim 1, further comprising:
a display for displaying a defect candidate excluded by said defect detector distinguishably from the other defect candidate.

4. The apparatus according to claim 1, wherein
one inspection part functions as said reference image inspection part and said target image inspection part.

5. The apparatus according to claim 1, wherein
a plurality of target images are acquired by said image pickup part, and at lease one of said plurality of supervisory images is included in said plurality of target images.

6. The apparatus according to claim 1, wherein
a pattern in each of said plurality of block areas on an object is formed with changing process parameters gradually in accordance with two-dimensional positions of said plurality of block areas, and said block area which is determined as said reference and at least one block area corresponding to at least one of said plurality of supervisory images are adjacent to each other.

7. A method of detecting a defect existing in a pattern on an object on which a predetermined pattern is formed in each of a plurality of block areas, with picking up images of said object, comprising the steps of:
a) detecting a defect included in a reference image representing a pattern in a block area which is determined as a reference on an object by comparing said reference image with a plurality of supervisory images each of which represent a pattern in selected block area;
b) detecting at least one defect candidate included in a target image representing a pattern in another block area by comparing said target image with said reference image; and
c) excluding a defect candidate overlapping with said defect included in said reference image from said at least one defect candidate on the basis of at least positional information of said defect included in said reference image.

8. The method according to claim 7, wherein
a defect candidate overlapping with said defect included in said reference image is excluded from said at least one defect candidate also on the basis of feature value of said defect included in said reference image and feature value of said at least one defect candidate in said step c).

9. The method according to claim 7, further comprising the step of:
displaying a defect candidate excluded in said step c) distinguishably from the other defect candidate.

10. The method according to claim 7, wherein
said step a) and said step b) are performed in one inspection part.

11. The method according to claim 7, wherein
a plurality of target images are acquired by picking up an image of said object, and at lease one of said plurality of supervisory images is included in said plurality of target images.

12. The method according to claim 7, wherein
a pattern in each of said plurality of block areas on an object is formed with changing process parameters gradually in accordance with two-dimensional positions of said plurality of block areas, and said block area which is determined as said reference and at least one block area corresponding to at least one of said plurality of supervisory images are adjacent to each other.
